(19) United States
(12) Patent Application Publication
(10) Pub. No.: US 2012/0254295 A1
(43) Pub. Date: Oct. 4, 2012

(54) SERVICE REQUEST RECEPTION CONTROL METHOD, APPARATUS, AND SYSTEM

(75) Inventors: Nobutaka MATSUMOTO, Saitama (JP); Michiaki HAYASHI, Saitama (JP); Kosuke NISHIMURA, Saitama (JP)

(73) Assignee: KDDI CORPORATION, Tokyo (JP)

(21) Appl. No.: 13/361,187

(22) Filed: Jan. 30, 2012

(30) Foreign Application Priority Data
Mar. 29, 2011 (JP) 2011-072236

(51) Int. Cl. G06F 15/16

(52) U.S. Cl. 709/203

(57) ABSTRACT

The present invention provides a service request reception control method which refuses a reception of the new service request without knowing the available quantity of hardware resource prospectively and without knowing the bottleneck reason prospectively.

The service request reception control method for reception control in a server device receiving a processing request from a plurality of client apparatuses comprises the steps of calculating a mean time required for a series of processing to the request from the client apparatus; determining a load state of service by comparing the mean time with a targeted service processing time; and refusing a request reception from the client apparatus based on the load state.

### PRIORITY CLAIM

This application claims priority from Japanese patent application No. 2011-072236, filed on Mar. 29, 2011, which is incorporated herein by reference.

### BACKGROUND OF THE INVENTION

1. Field of the Invention

The present invention relates to a service request reception control method, an apparatus and a system, which detect an overload state of service based on the time required for the service provision, and refuse a reception of a new service request.

2. Description of the Related Art

In a server client system that processing requests are given from a large number of clients to the server, independently, if the processing request exceeds the processing capacity of the server, a problem such as a server performance degradation or a system down may happen. To prevent a fall of service quality and the system down due to the overload state, several methods to refuse the reception of a surplus service request are suggested.

The first method is to handle with a software design. This method is to set prospectively a quantity of service request that is possible to receive in the server system, and to refuse the larger service request than it. For example, there is a web login control system limiting the number of the login by comparing the number of the current login with the number of the receivable login (Japanese patent publication No. 2008-242676). Also, there is a regulation method against several kinds of service start requests, the method manages the request by digitizing “load” per the requests and comparing it with a threshold (Japanese patent publication No. 2008-283307).

The second method is to handle with the observation of load situations of resources. This method is to monitor the rate of utilization of physical resources, which constitute the server device and the system, such as CPUs, memories, networks, etc., and to refuse the reception if the load exceeds the threshold. For example, there is a reception control method of the server computer monitoring the load state of the resource every function of the server, and comparing it with the threshold (Japanese patent publication No. 2000-322365). Also, there is a call reception control apparatus and a call reception control method monitoring the CPU utilization directly (Japanese patent publication No. 2004-048580).

### BRIEF SUMMARY OF THE INVENTION

However, the prior art 1 is not usable when a bottleneck is not clear, and it is necessary to design to all bottleneck candidates. Further, because the upper limit is decided without depending on a state of the hardware resource, there is a possibility that the hardware resource cannot be used up enough by setting the upper limit level in the design too low. In other words, the performance upper limit is limited with the upper limit level in the design rather than the hardware performance. On the contrary, the hardware resource becomes the bottleneck by setting the upper limit level in the design too high, there is a problem to have possibilities to fall into the overload state.

Also, the prior art 2 must know what hardware resource becomes the bottleneck prospectively, there is a problem that the design is difficult. Also, if the software implementation cannot finish up the hardware performance enough, there is a problem that the detection of the tightness of the hardware resource is difficult (an example: in the case of multi-core CPUs, the utilization upper limit can vary by the software implementation).

Therefore, it is an object of the present invention to realize the service request reception control method, the apparatus, and the system with the reception refusal, (1) which are possible to finish up the hardware resource without knowing the available quantity of hardware resource prospectively, and (2) which are possible to detect the reception of the surplus service request without knowing the bottleneck reason prospectively.

To realize the above object, according to a service request reception control method of the present invention, a service request reception control method for reception control in a server device receiving a processing request from a plurality of client apparatuses comprises the steps of: calculating a mean time required for a series of processing to the request from the client apparatus; determining a load state of service by comparing the mean time with a targeted service processing time; and refusing a request reception from the client apparatus based on the load state.

Further, it is also preferable that said calculating step calculates the mean time from a start time of the processing of the request from the client apparatus and an end time of the processing of the request from the client apparatus, the start time being a received time of a reservation request message in a two phase commit technique and the end time being a transmitted time of a commitment response message in the two phase commit technique.

Further, it is also preferable that said refusing step only selects the reservation request message in the two phase commit technique and refuses it.

Further, it is also preferable that said determining step determines again after refusing the request reception, when a predetermined number of the requests during processing are finished or when all requests are finished.

To realize the above object, according to a service request reception control apparatus of the present invention, a service request reception control apparatus for reception control in a server device receiving the processing request from a plurality of client apparatuses comprises: a means for calculating a mean time required for a series of processing to the request from the client apparatus; a means for determining a load state of service by comparing the mean time with a targeted service processing time; and a means for refusing a request reception from the client apparatus based on the load state.

To realize the above object, according to a service request reception control system of the present invention, the system comprises a plurality of client apparatuses, a server device receiving a processing request from a plurality of said client apparatuses, and a service request reception control apparatus described above.

According to the feature “which is possible to finish up the hardware resource without knowing the available quantity of hardware resource prospectively”, the present invention has the advantage to prevent a surplus and a lack of the hardware resources, which occurs by deviating a reception upper limit value in a design set by OS or software from the available quantity of hardware resources.

According to the feature “which is possible to detect the surplus service request without knowing the bottleneck reason prospectively”, the present invention has the advantage to prevent the overload without depending on the hardware configuration at the time of the system introduction.

### BRIEF DESCRIPTION OF THE SEVERAL VIEWS OF THE DRAWINGS

FIG. 1 shows a system constitution according to the embodiment of the present invention;

FIG. 2 shows a function constitution of the control request reception server according to the present invention;

FIG. 3 shows a processing flow of the system using the present invention; and

FIG. 4 shows an image of the calculation for the mean processing time.

### DETAILED DESCRIPTION OF THE INVENTION

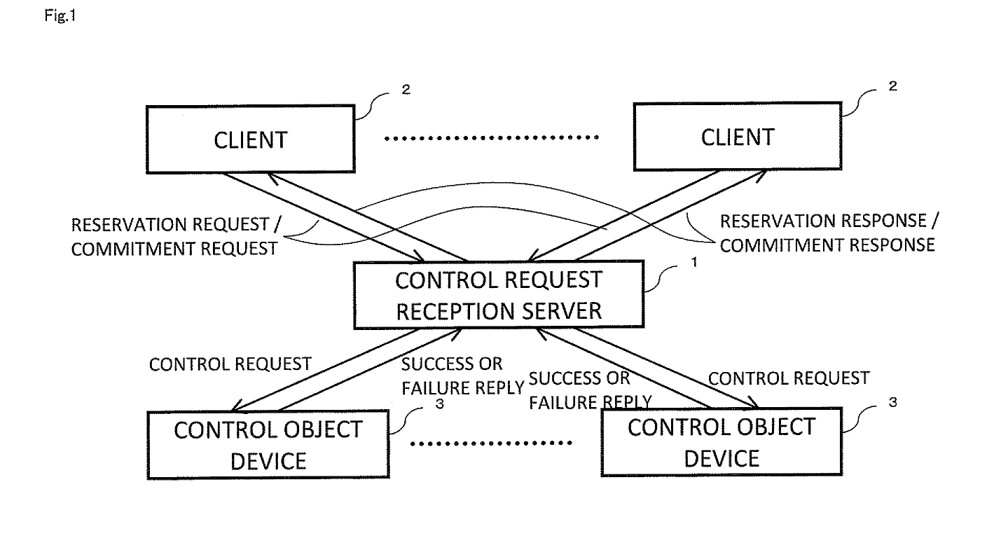

An embodiment of the present invention will be described below with reference to the drawings in detail. FIG. 1 shows a system constitution according to the embodiment of the present invention. This system comprises a control request reception server 1, a plurality of client apparatuses 2, and a plurality of control object devices 3. The control request reception server 1 receives a control request, which the clients 2 produce to the control object devices 3, selects an appropriate device based on the request content, and controls the devices 3. On this occasion, the request from the clients 2 is received with two phases of the reservation request/commitment request (the two phase commit technique).

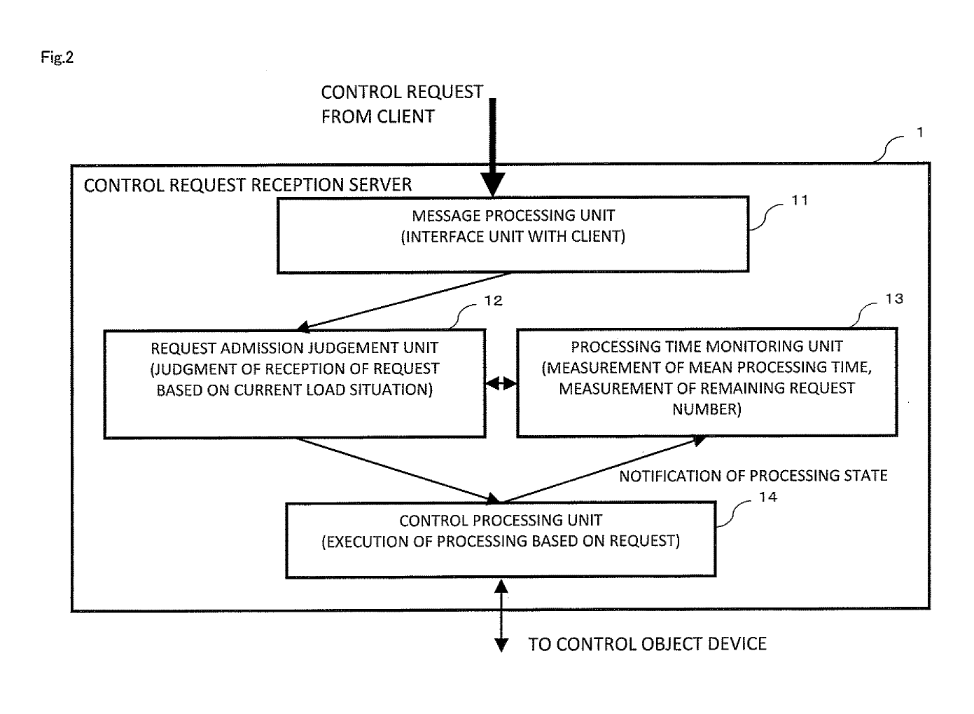

FIG. 2 shows a function constitution of the control request reception server according to the present invention. The control request reception server 1 comprises a message processing unit 11, a request admission judgment unit 12, a processing time monitoring unit 13, and a control processing unit 14.

The message processing unit 11 has a function to receive a request message from the client 2 and to extract a classification (it is the reservation request or the commitment request, or the other control messages) and a parameter of the message. Also, the unit 11 has a function to transmit a reply message to the client 2.

The request admission judgment unit 12 decides whether the reception of the reservation request is possible based on the current load situation. When the reception of the reservation request is possible, the unit 12 notifies to the control processing unit 14 so as to carry on the reservation request. When the reception is impossible, the unit 12 replies a negative reply. Also, as for the commitment request, the unit 12 notifies to the control processing unit 14 regardless of the load.

The processing time monitoring unit 13 accumulates a history of a time from the reception of the reservation request to the transmission of the commitment response (=the processing time), and notifies the load situation based on the processing time to the request admission judgment unit 12. When it is detected that the mean processing time exceeds than the threshold (the targeted service processing time), which is set as the target prospectively, the unit 13 notifies so as not to receive the further reservation request. Also, when a reception refusal state can be released, the unit 13 notifies to the request admission judgment unit 12 so as to receive the reservation request again (the cancellation of the reception refusal state will be described in the following in detail).

The control processing unit 14 controls the control object devices 3 based on the request. The unit 14 replies the success or failure of the processing to the message processing unit 11, after waiting all replies from the control object devices 3.

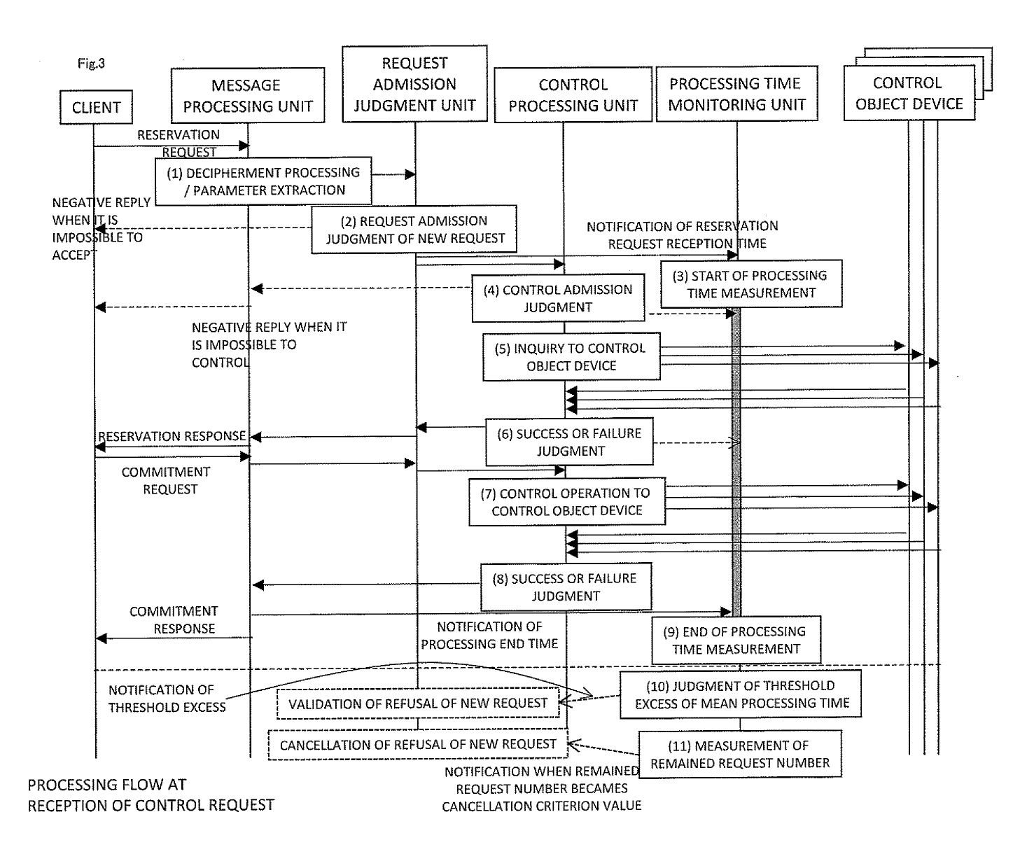

FIG. 3 shows a processing flow of the system using the present invention. Based on this flow, the operation of the control request reception server 1 will be described.
(1) Decipherment processing/Parameter extraction: The control request reception server 1 receives the request message of the reservation request from the clients 2. The message processing unit 11 decodes the request message, and determines the classification of the message. Since it is the reservation request, the server 1 extracts a parameter, and hands it to the request admission judgment unit 12.
(2) Reception admission judgment of new request: The request admission judgment unit 12 decides whether the reception of the reservation request is possible based on the current load situation.

When the refusal of new request is valid, the unit 12 replies a negative reply as it is impossible to receive the reservation request in the current load situation.

When the refusal of new request is invalid, since it is possible to receive, the unit 12 notifies a reservation request reception time to the processing time monitoring unit 13, and hands the parameter of the request message of the reservation request to the control processing unit 14.
(3) Start of the processing time measurement: The processing time monitoring unit 13 records a reservation request message received time as a reservation request reception time for the processing time measurement.
(4) Control admission judgment: The control processing unit 14 analyzes the above parameters, and determines whether the request is controllable.

In the case of the request that cannot be controlled by parameter abnormality, as control impossibility, the unit 14 replies a negative reply to the message processing unit 11. The message processing unit 11 notifies this negative reply to the clients 2. Note that, in this case, the unit 14 notifies a stop of the processing time measurement to the processing time monitoring unit 13.

In the case of the request that be controllable, it goes to the next processing.
(5) Inquiry to the control object device: The control processing unit 14 inquires to the control object device 3 whether the processing is possible with the above parameters. Here, when it is necessary to inquire to a plurality of control object devices 3 for the processing, the unit 14 inquires to a plurality of the control object devices 3.
(6) Success or failure judgment: After waiting in all replies from the control object devices 3, the unit 14 replies the success or failure of the processing to the message processing unit 11 through the request admission judgment unit 12. The message processing unit 11 returns a reservation response to the clients 2. When the reply from the control object devices 3 is failure, the unit 14 notifies a stop of the processing time measurement to the processing time monitoring unit 13. When the reply from the control object devices 3 is success, the control request reception server 1 receives the request message of the commitment request from the clients 2. The message processing unit 11 notifies to the processing time monitoring unit 13 through the request admission judgment unit 12.
(7) Control operation to the control object device: The control processing unit 14 controls the control object device 3 based on the request.
(8) Success or failure judgment: After waiting in all replies from the control object devices 3, the unit 14 replies the success or failure of the processing to the message processing unit 11. The message processing unit 11 notifies the processing end time to the processing time monitoring unit 13, and returns the commitment response to the clients 2.
(9) End of the processing time measurement: The processing time monitoring unit 13 records the time between the reservation request reception time and the commitment response message transmitted time as the processing time.

From the (1) to the (9), a series of processing from the reservation request from the client 2 to the commitment response is performed. Independently with it, the processing time monitoring unit 13 performs a threshold excess judgment of the mean processing time and a measurement of the remaining request number as follows.
(10) Threshold excess judgment of the mean processing time When the mean processing time exceeds the threshold Tth, the unit 13 notifies a threshold excess to the request admission judgment unit 12, and the request admission judgment unit 12 makes the refusal of new request valid. As described above, when the refusal of new request is made valid, the reservation request becomes the refusal object. If the commitment request is refused, it becomes non-efficiency, thus, the commitment request does not become the refusal object.
(11) Measurement of the remained request number: The unit 13 measures the number of the requests during processing from the reservation request from the client 2 to the commitment response.

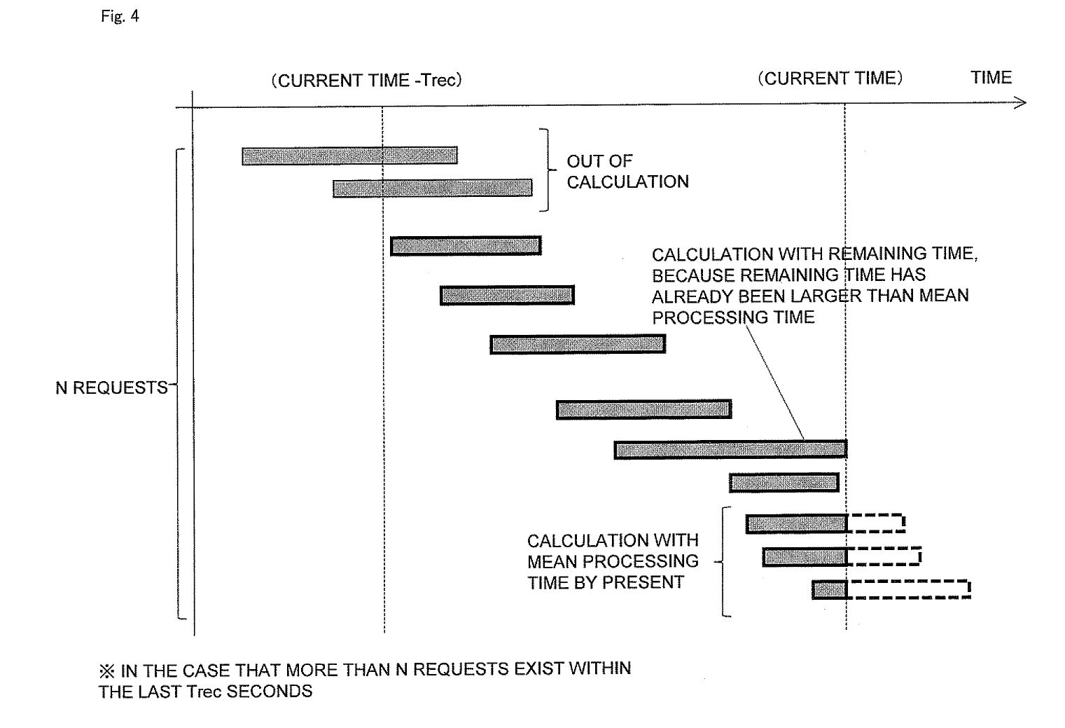

In the processing time monitoring unit 13, the mean processing time is detected as follow. FIG. 4 shows an image of the calculation for the mean processing time.

The processing time of one request is the time from the reception of the reservation request message to the transmission of the commitment response. However, to take into account the remaining request, the processing time of the request during processing is the larger one between “from the reception of the reservation request to the current time” and “the mean processing time by the present”. For example, in FIG. 4, the below three requests calculates with the mean processing time by the present, and the above two request calculates with the remaining time, because the remaining time has already been larger than the mean processing time.

To remove the processing time of an extremely old request, the calculation object request of the mean processing time is the smaller one between “the most recent N requests” and “the number of the requests received in the most recent Trec seconds”. In the case of FIG. 4, the receptions of the reservation request message before the N requests are before the Trec seconds, the above two requests in the FIG. 4 is excluded from the calculation. Note that, in FIG. 3, as for the request that is determined as the uncontrollable request by the control admission judgment and the request that the reply from the control object device 3 is failure at the success or failure judgment, the measurement of the processing time is stopped, thus, these requests are not included in the calculation object request.

In the processing time monitoring unit 13, the cancellation of the reception refusal state is carried out as follows. When either following is satisfied, the processing time monitoring unit 13 confirms whether the reception refusal state can be released.
(1) Completion of the processing of the M requests after the reception refusal.
(2) Completion of all remaining requests

In this case, the processing time monitoring unit 13 compares the mean processing time due to the most recent data and the threshold. If the mean processing time is less than or equal to the threshold, the reception refusal state is released, if the mean processing time is larger than the threshold, the reception refusal state is maintained (it waits for the completion of the M requests or all remaining requests).

Note that, a server administrator sets the various control parameters (Tth, Trec, N, M) described in the above to the control request reception server 1 prospectively manually.

The present invention is applicable to the control server system of the network apparatus. The control server of the network apparatus manages a plurality of apparatuses with one server, and a concentration of setup requests may occur. Also, since there is a possibility that the time for the control depends on the overload out of the server (the apparatus of the control object), it is not easy to estimate the bottleneck. Therefore, the present invention functions effectively.

As described above, the present invention monitors the processing time of the request from the clients, detects the degradation of the processing performance, and performs the reception control. Thus, it is easy to detect the performance stringency without being conscious of the point of the bottleneck (it does not need the conscious of characteristics of the hardware resources usage in the software implementation), further, the hardware performance of the system can be used up without being limited by the upper limit level in the design. Especially, the present invention can be applied to the server system that is hard to understand the bottleneck (examples: multistage server, apparatus control server) easily.

All the foregoing embodiments are by way of example of the present invention only and not intended to be limiting, and many widely different alternations and modifications of the present invention may be constructed without departing from the spirit and scope of the present invention. Accordingly, the present invention is limited only as defined in the following claims and equivalents thereto.

1. A service request reception control method for reception control in a server device receiving a processing request from a plurality of client apparatuses, the method comprising the steps of:
calculating a mean time required for a series of processing to the request from the client apparatus;
determining a load state of service by comparing the mean time with a targeted service processing time; and
refusing a request reception from the client apparatus based on the load state.

2. The service request reception control method according to claim 1, wherein said calculating step calculates the mean time from a start time of the processing of the request from the client apparatus and an end time of the processing of the request from the client apparatus,
the start time being a received time of a reservation request message in a two phase commit technique and the end time being a transmitted time of a commitment response message in the two phase commit technique.

3. The service request reception control method according to claim 1, wherein said refusing step only selects the reservation request message in the two phase commit technique and refuses it.

4. The service request reception control method according to claim 1, wherein said determining step determines again after refusing the request reception, when a predetermined number of the requests during processing are finished or when all requests are finished.

5. A service request reception control apparatus for reception control in a server device receiving a processing request from a plurality of client apparatuses, the apparatus comprising;
a means for calculating a mean time required for a series of processing to the request from the client apparatus;
a means for determining a load state of service by comparing the mean time with a targeted service processing time; and
a means for refusing a request reception from the client apparatus based on the load state.

6. A service request reception control system comprises a plurality of client apparatuses, a server device receiving a processing request from a plurality of said client apparatuses, and a service request reception control apparatus according to claim 5.
